(19) United States
(12) Patent Application Publication
(10) Pub. No.: US 2016/0330341 A1
(43) Pub. Date: Nov. 10, 2016

(54) ARRANGEMENT FOR AND METHOD OF DIFFERENTLY ILLUMINATING TARGETS TO BE ELECTRO-OPTICALLY READ IN DIFFERENT DAY AND NIGHT MODES OF OPERATION

(71) Applicant: SYMBOL TECHNOLOGIES, LLC, Lincolnshire, IL (US)

(72) Inventor: Charles Torzilli, East Northport, NY (US)

(21) Appl. No.: 14/704,425

(22) Filed: May 5, 2015

(51) Int. Cl. H04N 1/00; H04N 1/028

(52) U.S. Cl. CPC H04N 1/00997; H04N 1/00564; H04N 1/02815; H04N 1/00488; H04N 1/00334; H04N 2201/0096; H04N 2201/0081; H04N 2201/03112; H04N 2201/03145

(57) ABSTRACT

An illuminating light assembly in a healthcare scanner illuminates a target to be electro-optically read with visible illumination light of a first color, e.g., white, during a day mode, and illuminates the target with visible illumination light of a second, more psychologically soothing, color, e.g., red or amber, during a night mode. A solid-state imager captures an image of the illuminated target in either mode, and a controller processes the captured image in either mode.

### BACKGROUND OF THE INVENTION

The present disclosure relates generally to an arrangement for, and a method of, differently illuminating targets to be electro-optically read in different day and night modes of operation, of particular benefit in the healthcare field.

Imaging-based, healthcare scanners, each having a solid-state imager or image sensor, analogous to those conventionally used in consumer digital cameras, have been used to electro-optically read symbol targets, such as one- and two-dimensional bar code symbols and/or non-symbol targets or documents, such as prescriptions, labels, etc., in the healthcare field for many years. For example, it is known for healthcare providers, such as nurses and lab technicians, to operate healthcare scanners to capture return light from symbols provided on patients' wristbands, medication and specimen containers, vials, syringes, intravenous bags, and like medical equipment, to automatically read the symbols by image capture, and to thereby prevent manual errors in patient identification, medication administration, and specimen collection, as well as to better track medical assets.

In order to increase the amount of the return light captured by the imager, especially in dimly lit environments and/or at far range reading, such healthcare scanners also include an illuminating light assembly for illuminating the symbols with illumination light for reflection and scattering therefrom. In practice, the illumination light is bright and intense, which not only consumes and wastes electrical energy and degrades component lifetimes, but also, especially in a healthcare setting, is often perceived as bothersome, distracting and annoying to the patients, especially to a patient who is trying to rest or sleep at night. In addition, such healthcare scanners also typically include an on-board beeper or annunciator that provides audio feedback of a successful read of a symbol. The beeper is an electroacoustic transducer that converts electrical energy into mechanical energy to emit a single audible beeping tone, or a plurality of the same beeping tones, when the symbol has been successfully read. Such beeping tones might be tolerable during the day, but are still another source of disturbance to the patients, especially at night.

Accordingly, there is a need to capture images of symbols without always generating bright, intense light and without always generating audible beeping tones in a manner that insures that a patient, particularly a sleeping or resting patient, is not disturbed.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a side elevational view of a healthcare scanner operative for differently illuminating targets to be electro-optically read in different day and night modes of operation in accordance with this disclosure.

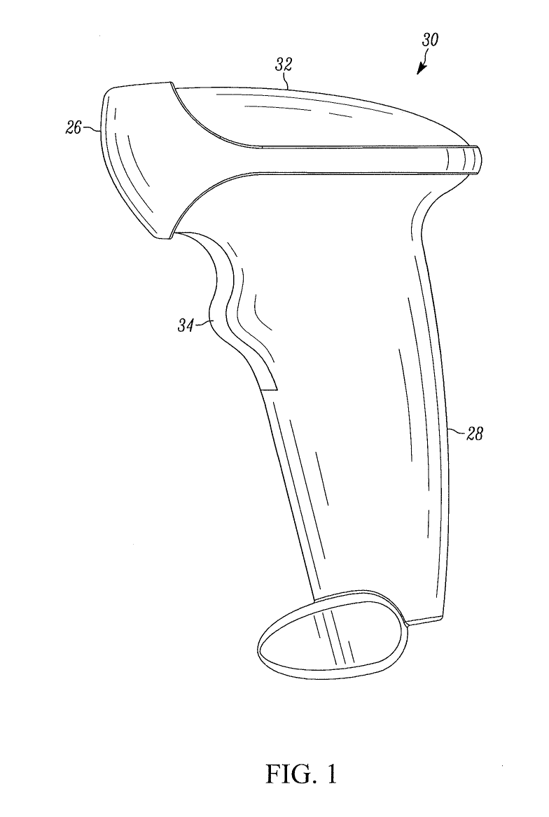

FIG. 2 is a schematic diagram of various components of the scanner of FIG. 1.

FIG. 3 is a flow chart depicting the steps performed in differently illuminating targets to be electro-optically read in different day and night modes of operation in accordance with this disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of this disclosure relates to an arrangement for differently illuminating targets, such as bar code symbols, to be electro-optically read in different day and night modes of operation. The arrangement includes an illuminating light assembly for illuminating a target with visible illumination light of a first color, e.g., white, during the day mode, and for illuminating the target with visible illumination light of a second color, e.g., red or amber, during the night mode that is different from the first color during the day mode. The arrangement also includes a solid-state imager for capturing an image of the illuminated target in either mode, and a controller for controlling the imager and the illuminating light assembly, and for processing the captured image in either mode. The red or amber color, as compared to the white color, is considered as psychologically more soothing, rather than stimulating and, as a result, the red or amber color produces less stress in nearby persons exposed to the illumination light. In a healthcare setting, this is of especial benefit to patients who are trying to rest or sleep at night.

In a preferred embodiment, an ambient light sensor detects the ambient light level, and sets the day mode when the ambient light level is above a threshold level, and sets the night mode when the ambient light level is below the threshold level. The ambient light sensor need not be a separate component, but may be the solid-state imager itself, which can sense ambient light levels. Advantageously, in the night mode, the controller disables an annunciator that normally emits audible beeps when the captured image has been successfully processed, and instead enables a vibrator to signify when the captured image has been successfully processed, thereby eliminating the beeps as another source of disturbance.

A method of differently illuminating targets to be electro-optically read in different day and night modes of operation, in accordance with another aspect of this disclosure, is performed by illuminating a target with visible illumination light of a first color during the day mode, illuminating the target with visible illumination light of a second color during the night mode that is different from the first color during the day mode, capturing an image of the illuminated target in either mode, and processing the captured image in either mode.

Turning now to the drawings, reference numeral 30 generally identifies a healthcare scanner or imaging reader that is ergonomically advantageously configured as a gun-shaped housing having an upper barrel or body 32 and a lower handle 28 tilted rearwardly away from the body 32. The housing is advantageously constituted of a disinfectant-ready, synthetic plastic material to allow it to be safely wiped down with a variety of chemicals that help prevent the spread of germs. A window 26 is located adjacent the front or nose of the body 32. The imaging reader 30 is typically held by the handle 28 in an operator's hand and used in a handheld mode in which a trigger 34 is manually depressed to initiate imaging of targets in a range of working distances relative to the window 26.

Housings having configurations, other than the gun-shape illustrated herein, can also be employed. For example, the reader 30 can be generally box-shaped and worn on a lanyard about a healthcare provider's neck, or it can be configured to fit in one's pocket. The reader 30 advantageously communicates with a remote host by a wireless link, and the reader 30 is electrically powered by an on-board battery. Alternatively, a non-illustrated cable could be connected to the reader 30 to deliver power and to support bidirectional communications between the host and the reader.

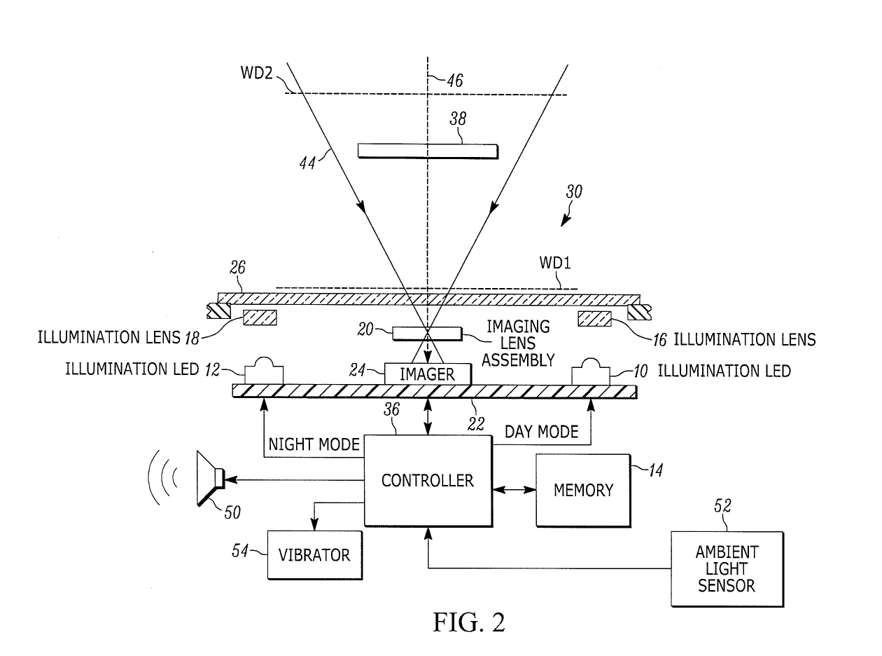

As schematically shown in FIG. 2, an imager 24 is mounted on a printed circuit board 22 in the reader 30. The imager 24 is a solid-state device, for example, a charge coupled device (CCD) or a complementary metal oxide semiconductor (CMOS) device having a one-dimensional array of addressable image sensors or pixels arranged in a single, linear row, or a two-dimensional array of such sensors arranged in mutually orthogonal rows and columns, preferably of megapixel resolution, and operative for detecting return light captured by an imaging lens assembly 20 over a field of view 44 along an optical path or axis 46 through the window 26. The return light is scattered and/or reflected from a symbol 38 over the field of view 44. The imaging lens assembly 20 is preferably operative for adjustably focusing and projecting the return light onto the array of image sensors to enable the symbol 38 to be read. The symbol 38 is located anywhere in a working range of distances between a close-in working distance (WD1) and a far-out working distance (WD2). In a preferred embodiment, WD1 is about one to two inches from the imager array 24, and WD2 can be several feet from the window 26.

In accordance with this disclosure, an illuminating light assembly is also mounted in the imaging reader 30 for illuminating the symbol 38 with visible illumination light of a first color, e.g., white, during a day mode of operation, and for illuminating the symbol 38 with visible illumination light of a second color, e.g., red or amber, during a night mode of operation that is different from the first color during the day mode of operation. In a preferred embodiment, the illuminating light assembly includes an illumination or white light source 10, e.g., one or more light emitting diodes (LEDs), and an illumination lens assembly 16 to uniformly illuminate the symbol 38 with an illuminating white light pattern during the day mode, and an illumination or red or amber light source 12, e.g., one or more LEDs, and an illumination lens assembly 18 to uniformly illuminate the symbol 38 with an illuminating red or amber light pattern during the night mode.

As shown in FIG. 2, the imager 24 and the illumination light sources 10, 12 are operatively connected to a controller or programmed microprocessor 36 operative for controlling the operation of these components. A memory 14 is connected and accessible to the controller 36. The controller 36 processes and decodes the symbol 38 into decoded data that identifies a patient, medication, or specimen associated with the symbol 38, and enables information to be sent to, or retrieved from, a medical database.

An ambient light sensor 52 is also operatively connected to the controller 36 to detect the ambient light level. When the ambient light level is above a threshold level stored in the memory 14, the sensor 52 advises the controller 36 to set the day mode. Similarly, when the ambient light level is below the threshold level stored in the memory 14, the sensor 52 advises the controller 36 to set the night mode. The ambient light sensor 52 need not be a separate component, but may be the solid-state imager 24 itself, which can sense ambient light levels. Alternatively, the day or night mode can be manually set by a healthcare provider by manually actuating a switch on the reader 30. Furthermore, the night mode can be set by having the reader 30 read a parameter symbol that advises the controller 36 to set the night mode. Still another technique for setting the night mode may be effected by depressing the trigger 34 for a lengthy period of time, e.g., nine seconds.

An on-board beeper 50 or annunciator is also operatively connected to the controller 36 to provide audio feedback of a successful read of the symbol 38 during the day mode, as described below. The beeper 50 is an electroacoustic transducer that converts electrical energy into mechanical energy to emit a single audible beeping tone, or a plurality of the same beeping tones, when the symbol 38 has been successfully read. An on-board vibrator 54 is also operatively connected to the controller 36 to provide vibrations of a successful read of the symbol 38 during the night mode, as described below. The vibrator 54 is an electromechanical transducer that converts electrical energy into one or more vibrations that are transmitted through the housing to an operator's hand in the form of haptic feedback when the symbol 38 has been successfully read.

In operation, the sensor 52 advises the controller to set the day mode or the night mode of operation, and the controller 36 sends a command signal to energize either the white illumination light source 10 (day mode) or the red/amber illumination light source 12 (night mode) for a short exposure time period, say 500 microseconds or less, and energizes and exposes the imager 24 to collect light, e.g., illumination light and/or ambient light, from the symbol 38 only during said exposure time period. A typical array needs about 16-33 milliseconds to acquire the entire symbol image and operates at a frame rate of about 30-60 frames per second. The controller 36 then processes and decodes the symbol 38 into decoded data that identifies a patient, medication, or specimen associated with the symbol 38.

In accordance with this disclosure, the second color, e.g., red or amber, at wavelengths above about 650 nanometers, as compared to the first color, e.g., white, is considered as psychologically more soothing, rather than stimulating and, as a result, the red or amber color produces less stress in nearby persons exposed to the illumination light. In a healthcare setting, this is of especial benefit to patients who are trying to rest or sleep at night. The luminous power or flux, as measured in lumens, is a measure of the perceived power of light and is an indicator of the varying sensitivity of the human eye to different wavelengths of light. The human eye is optimized to sense light at a wavelength of about 555 nanometers. In the preferred embodiment, the luminous power of the second color during the night mode is lower, e.g., about five times, than the luminous power of the first color during the day mode.

In addition, in the night mode, the controller 36 disables the beeper 50 that normally emits audible beeps during the day mode when the captured image has been successfully processed, and instead enables the vibrator 54 to signify when the captured image has been successfully processed, thereby eliminating the beeps as another source of disturbance to the patients.

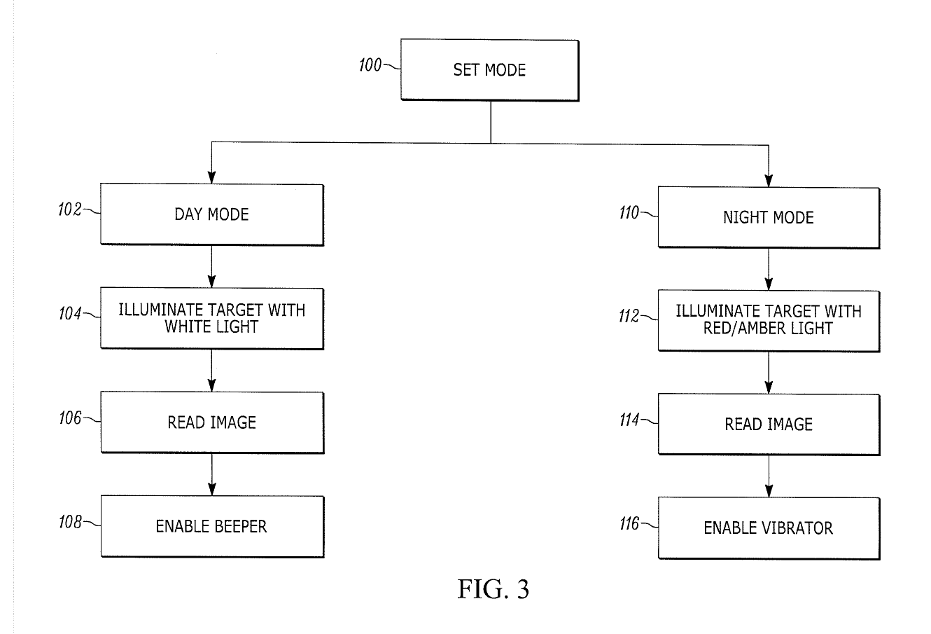

The method of this disclosure is performed, with reference to the flow chart of FIG. 3, by setting the mode (step 100), for example, by detecting the ambient light level, and thereby setting the day mode (step 102) or the night mode (step 110). In the day mode, the target 38 is illuminated with white light (step 104), an image of the illuminated target 38 is read (step 106), and the beeper 50 is actuated (step 108). In the night mode, the target 38 is illuminated with red/amber light (step 112), an image of the illuminated target 38 is read (step 114), and the vibrator 54 is actuated (step 116) to provide haptic feedback to an operator. Thus, disturbing lights and sounds are eliminated during the night mode of operation. As used herein, the term “day mode” is not intended to signify that the target 38 is illuminated with light of the first color during the hours of a day when the sun is present, e.g., during morning, afternoon and daytime hours, and that the term “night mode” is not intended to signify that the target 38 is illuminated with light of the second color during the hours of a day when the sun is not present, e.g., during evening and nighttime hours. Instead, the term “day mode” is intended to signify a time when bright lights and beeps are tolerable, and the term “night mode” is intended to signify a time when bright lights and beeps are not tolerable, e.g., a “quiet or stealth” mode.

In the foregoing specification, specific embodiments have been described. However, one of ordinary skill in the art appreciates that various modifications and changes can be made without departing from the scope of the invention as set forth in the claims below. For example, rather than emitting red/amber light, other colors, such as blue or green, that are generally perceived as psychologically soothing, could be employed. Also, rather than providing two independent illumination light sources 10, 12 to provide the different colored illumination, it is also possible to provide a single light source, and to drive it at different levels of drive current to provide the different colored illumination. It is also possible to change the color of the emitted illumination by moving an optical element, such as a colored shade, into or out of the path of the emitted illumination. In addition, although the imaging reader 30 described herein has been described as being particularly useful in a healthcare setting, it could also be employed in many other settings, for example, a retail setting, where bright lights and/or loud sounds may be disturbing to retail customers. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An arrangement for differently illuminating targets to be electro-optically read in different day and night modes of operation, comprising:
an illuminating light assembly for illuminating a target with visible illumination light of a first color during the day mode, and for illuminating the target with visible illumination light of a second color during the night mode that is different from the first color during the day mode;
a solid-state imager for capturing an image of the illuminated target in either mode; and
a controller for controlling the imager and the illuminating light assembly, and for processing the captured image in either mode.

2. The arrangement of claim 1, wherein the illuminating light assembly, the imager and the controller are mounted in a disinfectant-ready, handheld housing.

3. The arrangement of claim 1, wherein the illuminating light assembly includes a set of white illumination light sources for illuminating the target with the first color of white during the day mode, and a set of non-white illumination light sources for illuminating the target with the second color of non-white during the night mode.

4. The arrangement of claim 3, wherein the non-white illumination light sources are red or amber illumination light sources for illuminating the target with the second color of red or amber during the night mode.

5. The arrangement of claim 1, wherein the illumination light of the second color has a lower luminous power than the illumination light of the first color.

6. The arrangement of claim 1, and an ambient light sensor operatively connected to the controller for detecting ambient light level, and for setting the day mode when the ambient light level is above a threshold level, and for setting the night mode when the ambient light level is below the threshold level.

7. The arrangement of claim 6, wherein the ambient light sensor is the solid-state imager.

8. The arrangement of claim 1, and an annunciator for broadcasting an audible sound when the captured image has been successfully processed, and wherein the controller disables the annunciator in the night mode.

9. The arrangement of claim 1, and a vibrator for vibrating when the captured image has been successfully processed, and wherein the controller enables the vibrator in the night mode.

10. The arrangement of claim 1, wherein the imager includes an imaging array of sensors, and an imaging lens assembly for capturing return illumination light from the target over a field of view, and for projecting the return illumination light onto the imaging array to capture the image of the illuminated target over the field of view.

11. A method of differently illuminating targets to be electro-optically read in different day and night modes of operation, comprising:
illuminating a target with visible illumination light of a first color during the day mode;
illuminating the target with visible illumination light of a second color during the night mode that is different from the first color during the day mode;
capturing an image of the illuminated target in either mode; and
processing the captured image in either mode.

12. The method of claim 11, and performing the illuminating, capturing and processing in a disinfectant-ready, handheld housing.

13. The method of claim 11, wherein the illuminating during the day mode is performed with white light, and wherein the illuminating during the night mode is performed with non-white light.

14. The method of claim 13, wherein the illuminating during the night mode is performed with red or amber light.

15. The method of claim 11, and configuring the illumination light of the second color with a lower luminous power than the illumination light of the first color.

16. The method of claim 11, and detecting ambient light level, and setting the day mode when the ambient light level is above a threshold level, and setting the night mode when the ambient light level is below the threshold level.

17. The method of claim 11, and broadcasting an audible sound when the target has been successfully processed, and disabling the broadcast in the night mode.

18. The method of claim 11, and vibrating when the target has been successfully processed, and enabling the vibrating in the night mode.

19. The method of claim 11, and capturing return illumination light from the target over a field of view, and projecting the return illumination light onto an imaging array of sensors to capture the image of the illuminated target over the field of view.
